(19) United States
(12) Patent Application Publication
(10) Pub. No.: US 2016/0131246 A1
(43) Pub. Date: May 12, 2016

(54) TRANSMISSION DEVICE FOR VEHICLE

(71) Applicants: HYUNDAI MOTOR COMPANY, Seoul (KR); Kia Motors Corporation, Seoul (KR)

(72) Inventors: Han Gil PARK, Suwon-si (KR); Chang Hyun LEE, Seoul (KR); Yang Rae CHO, Suwon-si (KR)

(21) Appl. No.: 14/711,719

(22) Filed: May 13, 2015

(30) Foreign Application Priority Data
Nov. 11, 2014 (KR) 10-2014-0156083

(51) Int. Cl. F16H 59/10; F16H 63/42

(52) U.S. Cl. CPC F16H 59/10; F16H 63/42; F16H 2059/026

(57) ABSTRACT

A transmission device for a vehicle includes an interface body having a lever module which includes a shift knob and an electric device. An upper portion of a main body is replaceably assembled with the interface body. The interface body and the main body are separately provided and assembled each other to be used as the common shift lever system and to be applied to all kinds of vehicles even to a new car, thereby saving the development cost.

### CROSS REFERENCE TO RELATED APPLICATION

The present application claims the benefit of priority to Korean Patent Application No. 10-2014-0156083, filed on Nov. 11, 2014, the entire contents of which is incorporated herein for all purposes by this reference.

### TECHNICAL FIELD

The present disclosure relates to a transmission device for a vehicle used as a shift lever system and capable of replacing only a part of the transmission device that is exposed to outside.

### BACKGROUND

A vehicle transmission converts a torque and a rotation of an engine depending on a driving condition and is classified into a manual transmission, an automatic transmission, a continuously variable transmission, and the like depending on a shift mode.

The transmission may perform shifting to a desired shift stage by operating a shift lever. The shift mode is classified into a manual shift mode which may change a shift stage by a user and an automatic shift mode which automatically changes a shift stage depending on a speed when a user selects a driving mode.

In addition to this, a shift mode to enable a single transmission to perform manual shifting, and automatic shifting has been recently applied. That is, the shifting may be performed by manual shifting to increase or reduce a gear level while automatically shifting, or by implementing a transmission which may perform automatic shifting in addition to a transmission which may perform manual shifting.

The shift stage which is selected in an electronic transmission by a user may be, for example, parking (P), reverse (R), neutral (N), drive (D), and + and − where an engine brake is operated, and the like.

The electronic transmission uses a linear hall sensor or a switch hall sensor to sense a position of a shift lever, in which the hall sensor uses a magnet to convert a magnetic force into an electrical signal and to sense a selected shift stage using the electrical signal, thereby appreciating a position of the shift lever using the electrical signal and a voltage which is sensed by the hall sensor.

As lever operating parts including a shift knob, an indicator, and a function button and a shift lever body are integrally configured, the shift lever of the foregoing transmission may not be commonly used in other vehicle models and even though the shift lever is applied to other vehicle models, compatibility may be degraded.

Therefore, whenever a new vehicle is developed, the shift lever system needs to be newly developed as a whole, and as a result, development cost may be increased, and when a failure occurs, there is a need to replace the shift lever system as a whole.

Recently, as an interior aesthetics has become important. However, as the shift lever system is integrally configured, there may be many constraints in replacing the shift lever to satisfy customer demands.

Further, the shift lever has various electrical apparatuses such as the shift knob, the indicator, and the function buttons. Therefore, a kind of wires connecting each electric apparatus is diverse, such that assembling performance may be degraded, and there may be a limitation in adding additional functions.

The matters described as the related art have been provided only for assisting in the understanding for the background of the present disclosure and should not be considered as corresponding to the related art known to those skilled in the art.

### SUMMARY

An aspect of the present inventive concept provides a transmission device for a vehicle used as a shift lever system to be commonly applied to all vehicles and capable of replacing only parts which are exposed to outside to facilitate a replacement operation of parts at the time of a failure.

According to an exemplary embodiment of the present inventive concept, a transmission device for a vehicle includes an interface body having a lever module which includes a shift knob and an electric device. An upper portion of a main body is replaceably assembled with the interface body.

According to another exemplary embodiment of the present inventive concept, a transmission device for a vehicle includes an interface body having a lever module which includes a shift knob and an electric device and having a connection connector for receiving a power. An upper portion of a main body is assembled with the interface body. The main body has a main connector electrically connected to the connection connector to receive a current and to supply the power to the connection connector.

According to yet another exemplary embodiment of the present inventive concept, a transmission device for a vehicle includes an interface body having a lever module which includes a shift knob and an electric device and having a power receiver which receives an electromagnetic wave from outside. An upper portion of a main body is assembled with the interface body. The main body includes a power generator which receives a current to radiate the electromagnetic wave to outside such that the power is supplied to the power receiver.

### BRIEF DESCRIPTION OF THE DRAWINGS

The above and other objects, features and advantages of the present disclosure will be more clearly understood from the following detailed description taken in conjunction with the accompanying drawings.

FIG. 1 is a perspective view illustrating a transmission device for a vehicle according to a first exemplary embodiment of the present inventive concept.

FIG. 2 is a side view illustrating the transmission device for a vehicle illustrated in FIG. 1 according to the first exemplary embodiment of the present inventive concept.

FIG. 3 is a perspective view illustrating a transmission device for a vehicle according to a second exemplary embodiment of the present inventive concept.

FIG. 4 is a side view illustrating the transmission device for a vehicle illustrated in FIG. 3.

FIG. 5 is a view illustrating an electrical connection using wireless power of the transmission device for a vehicle of the present invention.

### DETAILED DESCRIPTION

Hereinafter, a transmission device for a vehicle according to exemplary embodiments of the present invention inventive concept will be described with reference to the accompanying drawings.

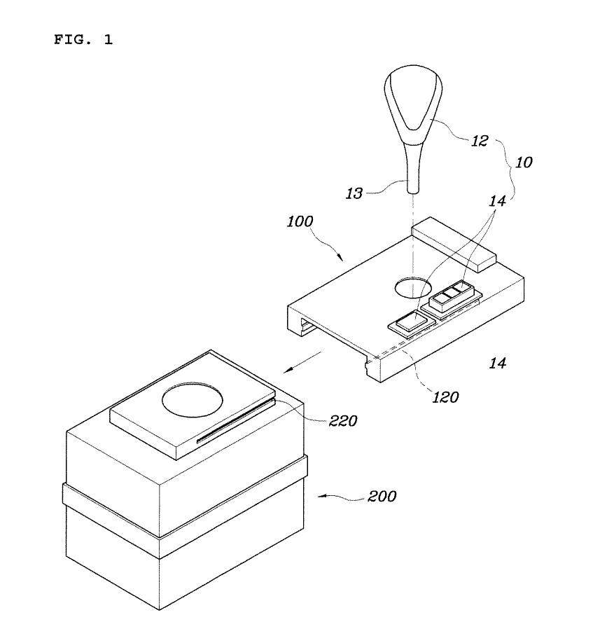

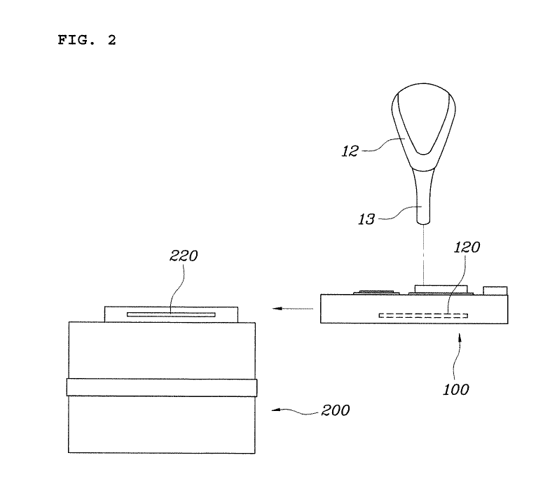

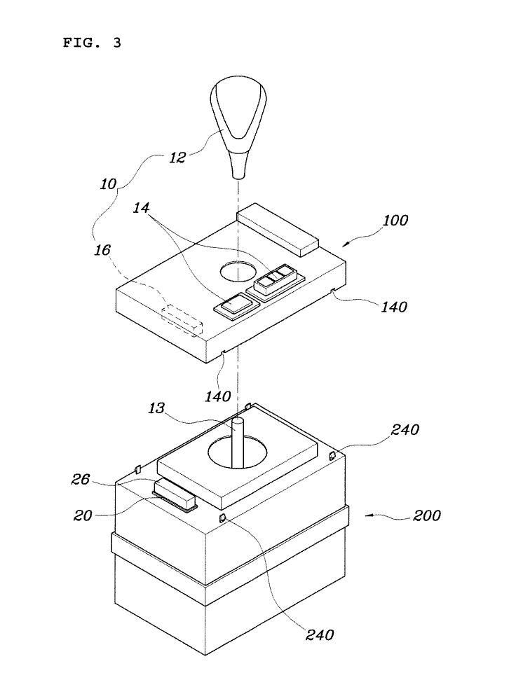

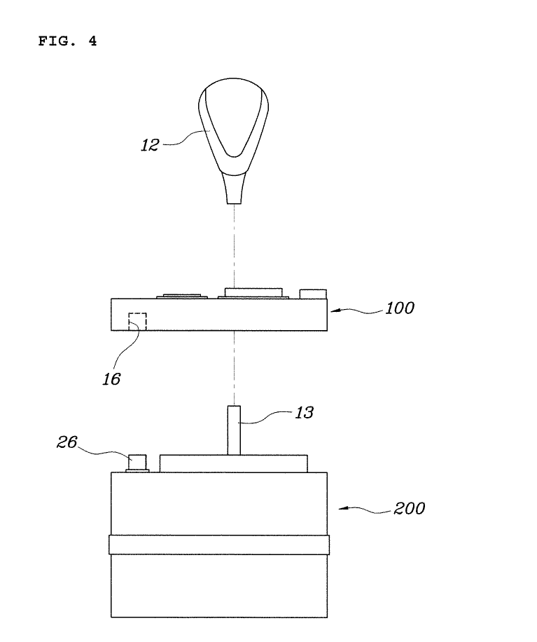

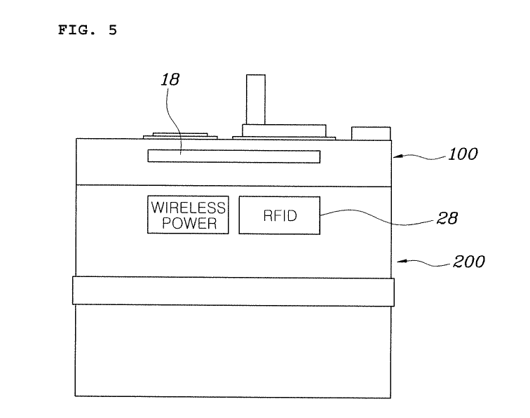

FIG. 1 is a perspective view illustrating a transmission device for a vehicle according to a first exemplary embodiment of the present inventive concept, FIG. 2 is a side view illustrating the transmission device for a vehicle illustrated in FIG. 1, FIG. 3 is a perspective view illustrating a transmission device for a vehicle according to a second exemplary embodiment of the present inventive concept, FIG. 4 is a side view illustrating the transmission device for a vehicle illustrated in FIG. 3, and FIG. 5 is a view illustrating an electrical connection using wireless power of the transmission device for a vehicle of the present invention.

The transmission device for a vehicle according to the exemplary embodiments of the present inventive concept may be commonly applied to the transmission device for various types of vehicles, in particular, an electronic shift lever. The transmission device for a vehicle according to the exemplary embodiments of the present inventive concept includes an interface body 100 having a lever module 10 which includes a shift knob 12 and an electric device 14. A main body 200 has an interface body 100 assembled at an upper portion thereof and includes a transmitting module 20 to be electrically connected to the lever module 10.

That is, the transmission device for a vehicle according to the exemplary embodiments of the present inventive concept includes the interface body 100 in which the lever module 10 which includes the shift knob 12 including design parts, various function buttons, an indicator (not shown), lighting (not shown), and the like is installed and the main body 200 which includes a position sensor of the shift lever and a controller depending on an operation of a function button and may have the transmitting module 20 connected to a power line to be supplied with electricity.

As such, the transmission device is separated into the interface body 100 and the main body 200, in which the main body 200 including the shift lever system is commonly used in all the vehicles. The interface body 100 is separately provided to be replaced, such that it is enough to replace only the interface body 100 of which the appearance design and the additional function are changed at the time of developing a new vehicle. Since, there is no need to develop the main body 200 for each vehicle model, development cost may be saved, and even though a failure of parts occurs, it is enough to replace only the interface body 100, thereby saving operation costs and time.

In particular, since the lever module 10 of the interface body 100 is electrically connected to the main body 200 through the transmitting module 20 which is disposed in the main body 200, electrical wires which extend from the existing indicator, lighting and function buttons are removed, thereby improving assembling performance and reducing the occurrence of errors due to the assembly. The transmitting module 20 will be again described below.

As such, the transmission device for a vehicle according to the exemplary embodiments of the present inventive concept is separated into the interface body 100 and the main body 200, and the lever module 10 included in the interface body 100 may be electrically connected to the main body 200 through the transmitting module 20 of the main body 200, thereby improving assembling performance, reducing the operation time and errors.

Describing the assembling of the interface body 100 and the main-body 200 according to the first exemplary embodiment of the present inventive concept, as illustrated in FIGS. 1 and 2, both ends of the upper portion of the main body 200 may extend horizontally with sliding grooves 220, and a lower portion of the interface body 100 may have sliding protrusions 120 protruding and inserted into the sliding grooves 220.

As such, the interface body 100 laterally slides on the main body 200, and thus, the interface body 100 is assembled with the main body 200 by assembling the sliding grooves 220 formed in the main body 200 and the sliding protrusions 120 formed in the interface body 100, thereby preventing the interface body 100 from separating upwardly.

As such, when the interface body 100 slidably moves on the main body 200 and the interface body 100 is assembled with the main body 200, the interface body 100 is assembled with the main body 200 and then the shift knob 12 and the shift lever 13 may be assembled with the main body 200.

As illustrated in FIGS. 3 and 4 according to the second exemplary embodiment of the present inventive concept, a hook 240 may protrude upwardly along a periphery of the upper portion of the main body 200, and the lower portion of the interface body 100 may have a locking groove 140 to which the hook 240 is inserted and locked.

As such, the upper portion of the main body 200 is provided with the hook 240, and the lower portion of the interface body 100 is provided with the locking groove 140 corresponding to the hook 240. Therefore, when the interface body 100 moves downwardly from the upper portion of the main body to be assembled with the main body 200, the hook 240 is inserted into the locking groove 140 and the hook 240 is locked to the locking groove 140, such that the interface body 100 is fixed to the main body 200.

In the case of the assembling method, the shift lever 13 is integrally installed in the main body 200 to assemble the interface body 100 at the upper portion of the main body 200 and then assemble the shift lever 13 in the shift knob 12.

The foregoing interface body 100 and main body 200 are assembled by the sliding method or the hooking and locking method and then may be firmly fixed to each other by bolting.

In detail, according to an electrical connection between the interface body 100 and the main body 200 of the present disclosure, as illustrated in FIG. 3, the transmitting module 20 is a main connector 26 which is positioned at the upper portion of the main body 200 and receives and supplies a current. The lever module 10 has a connection connector 16 which is positioned at the lower portion of the interface body 100 and corresponds to the main connector 26 to electrically connect the connection connector 16 to the main connector 26 when the interface body 100 is assembled with the main body 200.

That is, as the interface body 100 is provided with various function buttons, the indicator, and the lighting, the interface body 100 may have the connection connector 16 in which electric wires connected to the interface body 100 are integrated. The main body 200 may have the main connector 26 as the transmitting module 20 which is connected to a power line to receive electricity and is connected to wires corresponding to various functions of the lever module 10 included in the interface body 100.

The foregoing connection connector 160 and main connector 26 are connected to each other when the interface body 100 is assembled with the main body 200, such that the interface body 100 and the main body 200 are electrically connected to each other and the power supplied to the main connector 26 may be transferred to the connection connector 16 to operate various lighting devices and the indicator which are included in the interface body 100. Further, when the various function buttons included in the interface body 100 are operated, a corresponding command is transferred to a controller through the transmitting module 20 to perform the various functions.

According to another exemplary embodiment which electrically connects the interface body 100 to the main body 200, the transmitting module 20 is installed in the main body 200 and is configured as a power generator 28 which receives a current to radiate an electromagnetic wave to outside. The lever module 10 may be provided with a power receiver 18 which receives the electromagnetic wave sent from the power generator 28.

That is, the transmitting module 20 and the lever module 10 are electrically connected to each other by wireless power. The power generator 28 of the transmitting module 20 is configured of coils wound around plural times, and the power receiver 18 of the lever module 10 is configured of the coil corresponding to the power generator 28 and may be applied with a magnetic field coupling method which transfers the power between respective coils.

Further, the transmitting module 20 and the lever module 10 are each provided with a resonator which generates resonance at a specific frequency, and thus are applied with a method for transmitting the power depending on a resonance frequency, such that the transmitting module 20 and the lever module 10 may be electrically connected to each other.

The foregoing wireless power system may be applied with technologies and a wireless power method is variously well-known technologies, and therefore a detailed description thereof will be omitted.

The foregoing transmitting module 20 and lever module 10 are electrically connected to each other by the wireless power and may perform mutual communication using radio-frequency identification (RFID) communication to transfer the corresponding command to the main body 200 when operating various function buttons included in the interface body 100 and may transfer the corresponding command to the controller.

As a result, the wires are removed when the main body 200 is assembled with the interface body 100 to improve assembling performance and prevent failure and errors from occurring due to a short, thereby maintaining the stable operation.

Further, the electrical connection is simply performed only by assembling the main body 200 and the interface body 100 with each other, thereby making the operation process simpler.

The transmission device for a vehicle according to the exemplary embodiment of the present inventive concept as described above may include the interface body 100 having the lever module 10 which includes the shift knob 12 and the electric device 14, and the connection connector 16 for receiving a power. The main body 200 has the interface body 100 assembled at the upper portion thereof and has the main connector 26 electrically connected to the connection connector 16 to receive a current and supply the power to the connection connector 16. As such, the interface body 100 is separately formed from the main body 200, but the electrical connection between the interface body 100 and the main body 200 is made by connecting the connection connector 16 to the main connector 26 when the interface body 100 is assembled with the main body 200.

The transmission device for a vehicle according to another exemplary embodiment of the present inventive concept may include the interface body 100 having the lever module 10 which includes the shift knob 12 and the electric device 14, and the power receiver 18 receiving an electromagnetic wave from outside. The main body 200 comprises the interface body 100 assembled at the upper portion thereof and the power generator 28 receiving a current to radiate the electromagnetic wave to the outside so as to supply power to the power receiver 18. As such, the interface body 100 is separately formed from the main body 200, but the interface body 100 and the main body 200 are electrically connected to each other by the wireless power transmission between the power receiver 18 and the power generator 28 when the interface body 100 is assembled with the main body 200. Further, the commands for the function operation buttons of the interface body 100 may be transmitted by the RFID communication.

When electrically connecting the interface body 100 to the main body 200, the wires provided for each function are removed, and the interface body 100 is electrically connected to the main body 200 by the transmitting module, thereby improving assembling performance.

According to the transmission device for a vehicle having the foregoing structure, the interface body and the main body are separately provided and assembled each other to be used as the common shift lever system and to be applied to all kinds of vehicles even to a new car, thereby saving the development cost.

Further, the interface body exposed to the outside is separately configured in the shift lever to be replaced, thereby facilitating the replacement operation when a failure of the shift lever occurs and increasing freedom of design to satisfy the customer demands.

Although the present inventive concept has been shown and described with respect to specific exemplary embodiments, it will be obvious to those skilled in the art that the present disclosure may be variously modified and altered without departing from the spirit and scope of the present disclosure as defined by the following claims.

What is claimed is:

1. A transmission device for a vehicle, comprising:
an interface body having a lever module which includes a shift knob and an electric device; and
a main body at an upper portion of which the interface body is replaceably assembled.

2. The transmission device of claim 1, wherein the lever module is configured of the shift knob, an indicator, and illumination.

3. The transmission device of claim 1, wherein the upper portion of the main body has sliding grooves formed horizontally at opposite sides thereof, and the interface body has sliding protrusions protruding at a lower portion thereof and inserted into the sliding grooves.

4. The transmission device of claim 1, wherein the main body includes a hook protruding upwardly along a periphery at the upper portion thereof, and the interface body has a locking groove, to which the hook is inserted and locked, formed at a lower portion thereof.

5. The transmission device of claim 1, wherein the transmitting module is a main connector disposed at the upper portion of the main body to receive and supply a current, and the lever module includes a connection connector disposed at a lower portion of the interface body and corresponding to the main connector such that the main body receives the current by connecting the connection connector to the main connector when the interface body is assembled with the main body.

6. The transmission device of claim 1, wherein the transmitting module is a power generator installed in the main body and receives a current to radiate an electromagnetic wave to outside, and the lever module includes a power receiver which receives the electromagnetic wave sent from the power generator.

7. The transmission device of claim 4, wherein the hook is provided in plural.

8. A transmission device for a vehicle, comprising:
an interface body having a lever module which includes a shift knob and an electric device and having a connection connector for receiving a power; and
a main body of which the interface body is assembled at an upper portion, the main body having a main connector electrically connected to the connection connector to receive a current and supply the power to the connection connector.

9. A transmission device for a vehicle, comprising:
an interface body having a lever module which includes a shift knob and an electric device and having a power receiver which receives an electromagnetic wave from outside; and
a main body of which the interface body is assembled at the upper portion, the main body having a power generator which receives a current to radiate the electromagnetic wave to outside such that the power is supplied to the power receiver.

10. The transmission device of claim 1, wherein the main body includes a transmitting module which is electrically connected to the lever module.
